(19) United States
(12) Patent Application Publication
(10) Pub. No.: US 2019/0085127 A1
(43) Pub. Date: Mar. 21, 2019

(54) ANIONIC POLYMERISATION OF LACTAMS

(71) Applicant: BASF SE, Ludwigshafen am Rhein (DE)

(72) Inventors: Philippe Desbois, Edingen-Neckarhausen (DE); Rene Arbter, Freinsheim (DE); Bernd Bruchmann, Freinsheim (DE); Robert Stein, Altrip (DE); Frank Thielbeer, Mannheim (DE); Rolf Muelhaupt, Freiburg (DE); Tina Andrae, Mittweida (DE)

(21) Appl. No.: 15/760,665

(22) PCT Filed: Sep. 7, 2016
(86) PCT No.: PCT/EP2016/071111

§ 371 Date: Nov. 29, 2018

(30) Foreign Application Priority Data
Sep. 16, 2015 (EP) 15185507.9

(51) Int. Cl. C08G 69/18

(52) U.S. Cl. CPC C08G 69/18

(57) ABSTRACT

Provided herein is a process for producing a polyamide (P) by reaction of a mixture (M) including at least one lactam (component (A)), at least one catalyst (component (B)), at least one activator (component (C)), and at least one oxazolidine derivative (component (D)). Further provided herein is the mixture (M) and the use of an oxazolidine derivative for increasing the crystallization rate of a polyamide (P). Also provided herein is the use of an oxazolidine derivative in a polyamide (P) for producing a molded article from the polyamide (P) for reducing the demolding time of the molded article and the use of an oxazolidine derivative for removing water from a reaction mixture (RM).

The present invention relates to a process for producing a polyamide (P) by reaction of a mixture (M) comprising at least one lactam (component (A)), at least one catalyst (component (B)), at least one activator (component (C)) and at least one oxazolidine derivative (component (D)). The present invention further relates to the mixture (M) and to the use of an oxazolidine derivative for increasing the crystallization rate of a polyamide (P). The present invention further relates to the use of an oxazolidine derivative in a polyamide (P) for producing a molded article from the polyamide (P) for reducing the demolding time of the molded article and to the use of an oxazolidine derivative for removing water from a reaction mixture (RM).

Polyamides are generally semicrystalline polymers which are of particular industrial importance because they feature very good mechanical properties. In particular, they have high strength, stiffness, and toughness, good chemicals resistance, and also high abrasion resistance and tracking resistance. These properties are particularly important for the production of injection moldings. High toughness is particularly important for the use of polyamides as packaging films. On account of their properties polyamides are used in industry for the production of textiles such as fishing lines, climbing ropes, and carpeting. Polyamides are also used for producing wall plugs, screws and bolts, and cable ties. Polyamides are also used as paints, adhesives, and coating materials.

The production of molded articles of polyamides is advantageously effected by polymerization of the appropriate monomers directly in the mold starting from monomer powder, the polymerization being initiated in situ. Generally, only heating to a temperature above the melting point of the monomer is necessary. Heating to above the melting point of the polymer, which is typically higher than the melting point of the monomer, is generally not necessary.

The prior art discloses various processes for producing polyamides.

For example, DE 1 495 132 describes the polymerization of a lactam mixture which may comprise an acid chloride, an isocyanate or an isocyanate-releasing substance by addition of an alkali metal lactamate solution which comprises primary and/or secondary mono- and/or polyamines. The alkali metal lactamate solution may likewise comprise an acid chloride, an isocyanate or an isocyanate-releasing substance.

DE 4 002 260 describes the anionic polymerization of a caprolactam mixture which may comprise acid chlorides, isocyanates, substituted ureas, urethanes or guanidines by addition of a catalyst solution comprising a lactam, an alkali metal and also poly-C₁-C₄-alkylene glycol and a primary and/or secondary mono-and/or polyamine.

U.S. Pat. No. 3,216,977 describes the production of a polyamide from a lactam. In this document a lactam is reacted with an anionic catalyst and a substituted 2-methylene-1,3-oxazolidine-4,5-dione as cocatalyst.

U.S. Pat. No. 3,410,833 likewise describes a process for producing polyamides. In this document a lactam is reacted in the presence of an anionic catalyst and a cocatalyst produced from amides and oxalyl chloride. The cocatalyst is N-phenyl-2-methylen-oxazolidine-4,5-dione or N-methyl-2-benzylidene-oxazolidine-4,5-dione for example.

EP 0 786 486 describes a liquid multicomponent system for performing an anionic lactam polymerization. The liquid multicomponent system comprises a liquid solvating component, a catalyst and an activator. The solvating component is for example selected from lactams, ureas, carboxylic esters, polyether esters, sterically hindered phenols, phenol esters, N-alkylated amines and alkyl oxazolines. The solvating component is preferably a sterically hindered phenol, a phenol ester or a sterically hindered phenol ester.

The disadvantage of the processes described in the prior art is that the polymerization of the lactam must take place in the absence of water and oxygen. Thus, for example, EP 0 786 486 describes that phenolic phosphoric acid esters must additionally be used as scavengers for residual oxygen. In addition, the polyamides produced with the processes described in the prior art often have a high residual monomer content and the production of moldings requires lengthy cycle times. The moldings are additionally often difficult to remove from the molds.

The problem addressed by the present invention is accordingly that of providing a process for producing polyamides which exhibits the disadvantages of the processes described in the prior art only to a reduced extent if at all.

This object is achieved by a process for producing a polyamide (P) by reacting a mixture (M) comprising the components

(A) at least one lactam,

(B) at least one catalyst,

(C) at least one activator,

(D) at least one oxazolidine derivative.

It was found that, surprisingly, the use of at least one oxazolidine derivative in the mixture (M) causes the mixture (M) to exhibit reduced moisture sensitivity. Even mixtures (M) having a relatively high water content of for example 700 ppm can be reactivated with the oxazolidine derivative according to the invention so that a conversion into the polyamide (P) is possible even for these mixtures (M).

In addition, the shrinking time of a molded article produced with the mixture (M) according to the invention from the polyamide (P) is markedly reduced so that a more rapid demolding (i.e. a more rapid removal of the molded article from a mold) is possible. This results in shorter cycle times in the production of molded articles from the polyamide (P). In the context of the present invention the shrinking time is also referred to as the “demolding time”. The terms “shrinking time” and “demolding time” are therefore used synonymously in the context of the present invention and have the same meaning.

Not only is it possible to remove the molded article from the mold more rapidly with the mixture (M) according to the invention but the molded article is also easier to remove from the mold.

In addition, the use of the oxazolidine derivative results in an increase in the crystallization rate of the polyamide (P) and in an increase in the crystallization temperature of the polyamide (P).

It is also advantageous that several of the properties of the polyamide (P) produced in accordance with the invention are virtually identical to the physical properties of polyamides produced by other processes described in the prior art. Thus for example the polyamide (P) produced according to the invention exhibits the same density and similar behavior in dynamic mechanical analysis (DMA) as polyamides obtainable by processes described in the prior art.

The process according to the invention is more particularly elucidated hereinbelow.

Mixture (M)

According to the invention the mixture (M) comprises the components (A) at least one lactam, (B) at least one catalyst, (C) at least one activator and (D) at least one oxazolidine derivative.

The present invention accordingly also provides a mixture (M) comprising the components

(A) at least one lactam,

(B) at least one catalyst,

(C) at least one activator,

(D) at least one oxazolidine derivative.

The mixture (M) may comprise the components (A) to (D) in any desired amounts. Said mixture comprises for example in the range from 75 to 99.7 wt % of the component (A), in the range from 0.1 to 5 wt % of the component (B), in the range from 0.1 to 10 wt % of the component (C) and in the range from 0.1 to 10 wt % of the component (D) in each case based on the sum of the weight percentages of the components (A) to (D), preferably based on the total weight of the mixture (M).

The mixture (M) preferably comprises in the range from 85 to 99.1 wt % of the component (A), in the range from 0.2 to 3 wt % of the component (B), in the range from 0.5 to 5 wt % of the component (C) and in the range from 0.2 to 7 wt % of the component (D) in each case based on the sum of the weight percentages of the components (A) to (D), preferably based on the total weight of the mixture (M).

The mixture (M) especially preferably comprises in the range from 91 to 98.2 wt % of the component (A), in the range from 0.3 to 1 wt % of the component (B), in the range from 1 to 3 wt % of the component (C) and in the range from 0.5 to 5 wt % of the component (D) in each case based on the sum of the weight percentages of the components (A) to (D), preferably based on the total weight of the mixture (M).

The present invention accordingly also provides a process where the mixture (M) comprises in the range from 75 to 99.7 wt % of the component (A), in the range from 0.1 to 5 wt % of the component (B), in the range from 0.1 to 10 wt % of the component (C) and in the range from 0.1 to 10 wt % of the component (D) based on the total weight of the mixture (M).

The mixture (M) may further comprise at least one filler. Suitable fillers are known to one skilled in the art.

In the context of the present invention “at least one filler” is to be understood as meaning either precisely one filler or else a mixture of two or more fillers.

The at least one filler is for example selected from the group consisting of kaolin, chalk, wollastonite, talc, calcium carbonate, silicates, titanium dioxide, zinc oxide, graphite, glass beads, carbon nanotubes, carbon black, phyllosilicates, aluminum oxide, graphene, boron fibers, glass fibers, carbon fibers, silicic acid fibers, ceramic fibers, basalt fibers, aramid fibers, polyester fibers, nylon fibers, polyethylene fibers, wood fibers, flax fibers, hemp fibers and sisal fibers.

The mixture (M) comprises for example in the range from 0.1 to 90 wt %, preferably in the range from 1 to 50 wt % and especially preferably in the range from 2 to 30 wt % of the at least one filler based on the total weight of the mixture (M).

The mixture (M) may further comprise additives. Suitable additives are known to one skilled in the art and for example selected from the group consisting of stabilizers, dyes, antistats, filler oils, surface improvers, siccatives, demolding aids, release agents, antioxidants, light stabilizers, thermoplastic polymers, glidants, flame retardants, blowing agents, impact modifiers and nucleation aids.

It is preferable when the thermoplastic polymers employed as additives for example are not polyamides.

The mixture (M) comprises for example in the range from 0.1 to 20 wt %, preferably in the range from 0.2 to 10 wt % and especially preferably in the range from 0.3 to 5 wt % of additives based on the total weight of the polymerizable mixture (M).

The sum of the weight percentages of the components (A), (B), (C) and (D) and optionally of the at least one filler and of the additives typically add up to 100%. It will be appreciated that when the mixture (M) comprises no additives and no at least one filler the sum of the weight percentages of the components (A), (B), (C) and (D) typically adds up to 100%.

The components present in the mixture (M) are more particularly elucidated hereinbelow.

Component (A): Lactam

According to the invention the mixture (M) comprises at least one lactam as component (A).

In the context of the present invention “at least one lactam” is to be understood as meaning either precisely one lactam or else a mixture of two or more lactams. It is preferable in accordance with the invention when the mixture (M) comprises precisely one lactam as component (A).

In the present invention the terms “component (A)” and “at least one lactam” are used synonymously and therefore have the same meaning.

According to the invention “lectern” is preferably to be understood as meaning cyclic amides having 4 to 12 carbon atoms, preferably 6 to 12 carbon atoms, in the ring.

35

The present invention accordingly also provides a process where the component (A) present in the mixture (M) is at least one lactam having 4 to 12 carbon atoms.

Suitable lactams are for example selected from the group consisting of butyro-4-lactam (γ-lactam; γ-butyrolactam; pyrrolidone), 2-piperidone (δ-lactam; δ-valerolactam; piperidone), hexano-6-lactam (ε-lactam; ε-caprolactam), heptano-7-lactam (ζ-lactam; ζ-heptanolactam; enantholactam), octano-8-lactam (η-lactam; η-octanolactam; caprylolactam), nonano-9-lactam (θ-lactam; θ-nonanolactam), decano-10-lactam (ω-decanolactam; capric lactam), undecano-11-lactam (ω-undecanolactam) and dodecano-12-lactam (ω-dodecanolactam; laurolactam).

The present invention accordingly also provides a process where the component (A) present in the mixture (M) is selected from the group consisting of pyrrolidone, piperidone, ε-caprolactam, enantholactam, caprylolactam, capric lactam and laurolactam.

The lactams may be unsubstituted or at least monosubstituted. In the case where at least monosubstituted lactams are employed the ring carbon atoms thereof may bear one, two, or more substituents each independently selected from the group consisting of C₁- to C₁₀-alkyl, C₅- to C₆-cycloalkyl, and C₅- to C₁₀-aryl.

The component (A) is preferably unsubstituted.

Suitable C₁- to C₁₀-alkyl substituents are for example methyl, ethyl, propyl, isopropyl, n-butyl, sec-butyl, and tert-butyl. A suitable C₅- to C₆-cycloalkyl substituent is for example cyclohexyl. Preferred C₅- to C₁₀-aryl substituents are phenyl and anthranyl.

It is particularly preferable to employ unsubstituted lactams, preference being given to 12-dodecanolactam (ω-dodecanolactam) and ε-lactam (ε-caprolactam). ε-lactam (ε-caprolactam) is most preferred.

ε-Caprolactam is the cyclic amide of caproic acid. It is also called 6-aminohexanolactam, 6-hexanolactam or caprolactam. Its IUPAC name is “Acepan-2-one”. Caprolactam has the CAS number 105-60-2 and the general formula C₆H₁₁NO. Processes for producing caprolactam are known to one skilled in the art.

The component (A) present in the mixture (M) typically has a melting point T_{M(A)}. The melting point T_{M(A)} of the component (A) present in the mixture (M) is for example in the range from 20° C. to 250° C., preferably in the range from 50° C. to 200° C. and especially preferably in the range from 70° C. to 160° C. determined by differential scanning calorimetry, DSC.

It will be appreciated by one skilled in the art that when the mixture (M) comprises two or more lactams as component (A) these two or more lactams may also have different melting points T_{M(A)}. The component (A) may then have two or more melting points T_{M(A)}, wherein these two or more melting points T_{M(A)} are then preferably all in the abovementioned ranges.

Component (B): Catalyst

According to the invention the mixture (M) comprises at least one catalyst as component (B).

In the context of the present invention “at least one catalyst” is to be understood as meaning either precisely one catalyst or else a mixture of two or more catalysts. It is preferable in accordance with the invention when the mixture (M) comprises precisely one catalyst as component (B).

In the present invention the descriptions “component (B)” and “at least one catalyst” are used synonymously and therefore have the same meaning.

The at least one catalyst is preferably a catalyst for the anionic polymerization of a lactam. The at least one catalyst therefore preferably enables the formation of lactam anions. The at least one catalyst is thus capable of forming lactamates by removing the nitrogen-bonded proton of the at least one lactam (component (A)).

Lactam anions themselves can likewise function as the at least one catalyst. The at least one catalyst may also be referred to as an initiator.

Suitable components (B) are known per se to one skilled in the art and are described for example in “Polyamide. Kunststoff-Handbuch”, Carl-Hanser-Verlag 1998.

The component (B) is preferably selected from the group consisting of alkali metal lactamates, alkaline earth metal lactamates, alkali metals, alkaline earth metals, alkali metal hydrides, alkaline earth metal hydrides, alkali metal hydroxides, alkaline earth metal hydroxides, alkali metal alkoxides, alkaline earth metal alkoxides, alkali metal amides, alkaline earth metal amides, alkali metal oxides, alkaline earth metal oxides, and organometallic compounds.

The present invention accordingly also provides a process where the component (B) present in the mixture (M) is selected from the group consisting of alkali metal lactamates, alkaline earth metal lactamates, alkali metals, alkaline earth metals, alkaline metal hydrides, alkaline earth metal hydrides, alkali metal hydroxides, alkaline earth metal hydroxides, alkali metal alkoxides, alkaline earth metal alkoxides, alkali metal amides, alkaline earth metal amides, alkali metal oxides, alkaline earth metal oxides, and organometallic compounds.

The component (B) is particularly preferably selected from alkali metal lactamates and alkaline earth metal lactamates.

Alkali metal lactamates are known per se to one skilled in the art. Suitable alkali metal lactamates are for example sodium caprolactamate and potassium caprolactamate.

Suitable alkaline earth metal lactamates are for example magnesium bromide caprolactamate, magnesium chloride caprolactamate, and magnesium biscaprolactamate. Suitable alkali metals are for example sodium and potassium, and examples of suitable alkaline earth metals are magnesium and calcium. Suitable alkali metal hydrides are for example sodium hydride and potassium hydride, and suitable alkali metal hydroxides are for example sodium hydroxide and potassium hydroxide. Suitable alkali metal alkoxides are for example sodium methoxide, sodium ethoxide, sodium propoxide, sodium butoxide, potassium methoxide, potassium ethoxide, potassium propoxide, and potassium butoxide.

In a further especially preferred embodiment the component (B) is selected from the group consisting of sodium hydride, sodium, sodium caprolactamate, and a solution of sodium caprolactamate in caprolactam. Particular preference is given to sodium caprolactamate and/or a solution of sodium caprolactamate in caprolactam (for example Brüggolen C10, 17 to 19 wt % of sodium caprolactamate and caprolactam). The at least one catalyst may be employed as a solid or in solution. The at least one catalyst is preferably employed as a solid. The catalyst is especially preferably added to a caprolactam melt in which it can be dissolved.

It will be appreciated by one skilled in the art that when the component (B) is for example an alkali metal this reacts on contact with the at least one lactam (component (A)) to form an alkali metal lactamate.

Component (C): Activator

According to the invention the mixture (M) comprises at least one activator as component (C).

In the context of the present invention “at least one activator” is to be understood as meaning either precisely one activator or else a mixture of two or more activators. It is preferable in accordance with the invention when the mixture (M) comprises precisely one activator as component (C).

In the context of the present invention the terms “component (C)” and “at least one activator” are used synonymously and therefore have the same meaning.

Any activator known to one skilled in the art and suitable for activating the anionic polymerization of the at least one lactam (component (A)) is suitable as the at least one activator. The component (C) is preferably selected from the group consisting of carbodiimides, isocyanates, acid anhydrides, acid halides and the reaction products thereof with the component (A).

The present invention accordingly also provides a process where the component (C) present in the mixture (M) is selected from the group consisting of carbodiimides, isocyanates, acid anhydrides, acid halides and the reaction products thereof with the component (A).

Suitable isocyanates are for example aliphatic diisocyanates such as butylene diisocyanate, hexamethylene diisocyanate, octamethylene diisocyanate, decamethylene diisocyanate, undecamethylene diisocyanate, dodecamethylene diisocyanate, 4,4-methylenebis(cyclohexyl isocyanate) and isophorone diisocyanate. Likewise suitable are aromatic diisocyanates such as tolyl diisocyanate and 4,4′-methylenebis(phenyl isocyanate) and polyisocyanates such as isocyanates of for example hexamethylene diisocyanate which are also known as “Basonat HI100” from BASF SE. Likewise suitable are allophanates such as ethyl allophanates for example.

Suitable acid halides are for example aliphatic diacid halides such as butylene diacid chloride, butylene diacid bromide, hexamethylene diacid chloride, hexamethylene diacid bromide, octamethylene diacid chloride, octamethylene diacid bromide, decamethylene diacid chloride, decamethylene diacid bromide, dodecamethylene diacid chloride, dodecamethylene diacid bromide, 4,4′-methylenebis(cyclohexyl acid chloride), 4,4′-methylenebis(cyclohexyl acid bromide), isophorone diacid chloride and isophorone diacid bromide. Likewise suitable acid halides are for example aromatic diacid halides such as tolylmethylene diacid chloride, tolylmethylene diacid bromide, 4,4′-methylenebis(phenyl) acid chloride and 4,4′-methylenebis(phenyl) acid bromide.

In a preferred embodiment the component (C) is selected from the group consisting of hexamethylene diisocyanate, isophorone diisocyanate, hexamethylene diacid bromide and hexamethylene diacid chloride. Component (C) is especially preferably hexamethylene diisocyanate.

It will be appreciated by one skilled in the art that the at least one activator forms an activated lactam in situ with the at least one lactam (A). This forms activated N-substituted lactams, for example acyl lactam. The relevant reactions are known to one skilled in the art.

The at least one activator may be employed in solution or without a solvent and it is preferable when the at least one activator is dissolved in caprolactam.

Accordingly, Brüggolen C 20, 80% caprolactam-blocked 1,6-hexamethylene diisocyanate in Caprolactam from Brüggemann DE, is also suitable as the at least one activator.

Component (D): Oxazolidine Derivative

According to the invention the mixture (M) comprises at least one oxazolidine derivative as component (D).

In the context of the present invention “at least one oxazolidine derivative” is to be understood as meaning either precisely one oxazolidine derivative or else a mixture of two or more oxazolidine derivatives. It is preferable in accordance with the invention when the mixture (M) comprises precisely one oxazolidine derivative as component (D).

In the context of the present invention “oxazolidine derivative” is to be understood as meaning compounds derived from oxazolidine.

Oxazolidine is known to those skilled in the art. Oxazolidine is a heterocyclic saturated hydrocarbon compound comprising a five-membered ring which comprises a nitrogen atom (N-atom) and an oxygen atom (O-atom).

In the context of the present invention the description “oxazolidine derivative” therefore does not encompass any compound derived from oxazolidinone.

Oxazolidinone is likewise known to those skilled in the art. Oxazolidinone is a heterocyclic hydrocarbon compound comprising a five-membered ring which comprises a nitrogen atom and an oxygen atom and a carbonyl group (C═O).

Moreover, in the context of the present invention the description “oxazolidine derivative” therefore does not encompass any compound derived from oxazoline.

Oxazoline is known to those skilled in the art. Oxazoline is a heterocyclic unsaturated hydrocarbon compound comprising a five-membered ring which comprises a C—C double bond, a nitrogen atom and an oxygen atom.

The present invention accordingly also provides a process in which the component (D) does not comprise any compound derived from oxazolidinone.

The present invention further provides a process in which the component (D) does not comprise any compound derived from oxazoline.

In the context of the present invention the descriptions “component (D)” and “at least one oxazolidine derivative” are used synonymously and therefore have the same meaning.

Suitable components (D) are known to one skilled in the art. It is preferable in accordance with the invention when the at least one oxazolidine derivative (component (D)) is selected from the group consisting of an oxazolidine derivative of general formula (I)

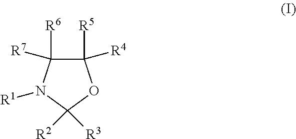

where
R¹, R², R³, R⁴, R⁵, R⁶ and R⁷ are each independently selected from the group consisting of hydrogen, unsubstituted or at least monosubstituted C₁-C₃₀-alkyl and unsubstituted or at least monosubstituted C₅-C₃₀-aryl,
   wherein
   the substituents are selected from the group consisting of NR^{a}R^{b}, OR^{c}, C₁-C₁₀-alkyl, C₅-C₁₀-aryl, F, Cl and Br,
   wherein
   R^{a}, R^{b} and R^{c} are each independently selected from the group consisting of hydrogen and unsubstituted C₁-C₁₀-alkyl;
      and an oxazolidine derivative of general formula (II)

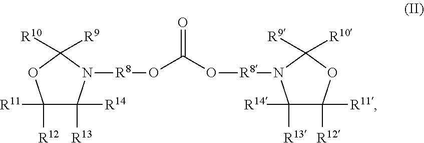

where
R⁸ and R^{8′} are each independently selected from the group consisting of unsubstituted or at least monosubstituted C₁-C₁₀-alkanediyl,
   wherein
   the substituents are selected from the group consisting of C₁-C₁₀-alkyl;
R⁹, R^{9′}, R¹⁰, R^{10′}, R¹¹, R^{11′}, R¹², R^{12′}, R¹³, R^{13′}, R¹⁴ and R^{14′} are each independently selected from the group consisting of hydrogen, unsubstituted or at least monosubstituted C₁-C₃₀-alkyl and unsubstituted or at least monosubstituted C₅-C₃₀-aryl,
   wherein
   the substituents are selected from the group consisting of NR^{d}R^{e}, OR^{f}, C₁-C₁₀-alkyl, C₅-C₁₀-aryl, F, Cl and Br,
   wherein
   R^{d}, R^{e} and R^{f} are each independently selected from the group consisting of hydrogen and unsubstituted C₁-C₁₀-alkyl.

The present invention accordingly also provides a process where the at least one oxazolidine derivative (component (D)) is selected from the group consisting of an oxazolidine derivative of general formula (I)

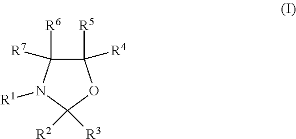

where
R¹, R², R³, R⁴, R⁵, R⁶ and R⁷ are each independently selected from the group consisting of hydrogen, unsubstituted or at least monosubstituted C₁-C₃₀-alkyl and unsubstituted or at least monosubstituted C₅-C₃₀-aryl,
   wherein
   the substituents are selected from the group consisting of NR^{a}R^{b}, OR^{c}, C₁-C₁₀-alkyl, C₅-C₁₀-aryl, F, Cl and Br,
   wherein
   R^{a}, R^{b} and R^{c} are each independently selected from the group consisting of hydrogen and unsubstituted C₁-C₁₀-alkyl,
      and an oxazolidine derivative of general formula (II)

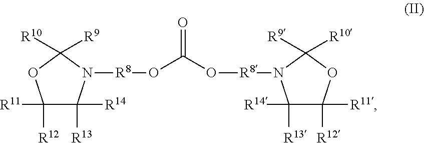

where
R⁸ and R^{8′} are each independently selected from the group consisting of unsubstituted or at least monosubstituted C₁-C₁₀-alkanediyl,
   wherein
   the substituents are selected from the group consisting of C₁-C₁₀-alkyl;
R⁹, R^{9′}, R¹⁰, R^{10′}, R¹¹, R^{11′}, R¹², R^{12′}, R¹³, R^{13′}, R¹⁴ and R^{14′} are each independently selected from the group consisting of hydrogen, unsubstituted or at least monosubstituted C₁-C₃₀-alkyl and unsubstituted or at least monosubstituted C₅-C₃₀-aryl,
   wherein
   the substituents are selected from the group consisting of NR^{d}R^{e}, OR¹, C₁-C₁₀-alkyl, C₅-C₁₀-aryl, F, Cl and Br,
   wherein
   R^{d}, R^{e} and R^{f} are each independently selected from the group consisting of hydrogen and unsubstituted C₁-C₁₀-alkyl.

The oxazolidine derivative of general formula (I) is also referred to as “oxazolidine derivative (I)” in the context of the present invention and the oxazolidine derivative of general formula (II) is also referred to as “oxazolidine derivative (II)” in the context of the present invention. The terms “oxazolidine derivative of general formula (I)” and “oxazolidine derivative (I)” are therefore used synonymously and have the same meaning. Likewise, the terms “oxazolidine derivative of general formula (II)” and “oxazolidine derivative (II)” are used synonymously and likewise have the same meaning.

In a preferred embodiment of the present invention the substituents in the at least one oxazolidine derivative (I) are as follows
R¹, R² and R³ are each independently selected from the group consisting of hydrogen and unsubstituted or at least monosubstituted C₁-C₂₀-alkyl,
   wherein
   the substituents are selected from the group consisting of NR^{a}R^{b}, OR^{c}, and C₁-C₁₀-alkyl,
   wherein
   R^{a}, R^{b} and R^{c} are each independently selected from the group consisting of hydrogen and unsubstituted C₁-C₅-alkyl;
R⁴, R⁵, R⁶ and R⁷ are each independently selected from the group consisting of hydrogen, unsubstituted C₁-C₂₀-alkyl and unsubstituted C₅-C₂₀-aryl.

In a particularly preferred embodiment the substituents of the at least one oxazolidine derivative (I) are as follows:
R¹, R² and R³ are each independently selected from the group consisting of hydrogen and unsubstituted or at least monosubstituted C₁-C₂₀-alkyl,
   wherein
   the substituents are selected from the group consisting of NH₂, OH and C₁-C₅-Alkyl;
R⁴ and R⁶ are hydrogen;
R⁵ and R⁷ are each independently selected from the group consisting of hydrogen and unsubstituted C₁-C₂₀-alkyl.

In a more preferred embodiment the substituents of the at least one oxazolidine derivative (I) are as follows:
R¹ is selected from the group consisting of hydrogen and unsubstituted C₁-C₂₀-alkyl,
R² is selected from the group consisting of hydrogen and unsubstituted or at least monosubstituted C₁-C₂₀-alkyl,
   wherein
   the substituents are selected from the group consisting of NH₂, OH and C₁-C₅-Alkyl;
R³, R⁴, R⁵, R⁶ and R⁷ are each hydrogen.

In a most preferred embodiment the substituents of the at least one oxazolidine derivative (I) are as follows:
R¹ is selected from the group consisting of hydrogen and unsubstituted C₁-C₄-alkyl,
R² is selected from the group consisting of hydrogen and unsubstituted or at least monosubstituted C₁-C₆-alkyl,
   wherein
   the substituents are selected from the group consisting of C₁-C₅-alkyl;
R³, R⁴, R⁵, R⁶ and R⁷ are each hydrogen.

In a preferred embodiment of the present invention the substituents of the oxazolidine derivative (II) are as follows:
R⁸ and R^{8′} are each independently selected from the group consisting of unsubstituted or at least monosubstituted C₁-C₁₀-alkanediyl,
   wherein
   the substituents are selected from the group consisting of C₁-C₁₀-alkyl;
R⁹, R^{9′}, R¹⁰, R^{10′} are each independently selected from the group consisting of hydrogen, unsubstituted or at least monosubstituted C₁-C₂₀-alkyl and unsubstituted or at least monosubstituted C₅-C₂₀-aryl,
   wherein
   the substituents are selected from the group consisting of C₁-C₁₀-alkyl;
R¹¹, R^{11′}, R¹², R^{12′}, R¹³, R^{13′}, R¹⁴ and R^{14′} are each independently selected from the group consisting of hydrogen, unsubstituted C₁-C₂₀-alkyl and unsubstituted C₅-C₂₀-aryl.

In a particularly preferred embodiment of the present invention the substituents of the oxazolidine derivative (II) are as follows:
R⁸ and R^{8′} are each independently selected from the group consisting of unsubstituted C₁-C₁₀-alkanediyl,
R⁹, R^{9′}, R¹⁰, R^{10′} are each independently selected from the group consisting of hydrogen, unsubstituted or at least monosubstituted C₁-C₁₀-alkyl,
   wherein
   the substituents are selected from the group consisting of C₁-C₅-alkyl;
R¹¹, R^{11′}, R¹³ and R^{13′} are hydrogen;
R¹², R^{12′}, R¹⁴ and R^{14′} are each independently selected from the group consisting of hydrogen, unsubstituted C₁-C₂₀-alkyl and unsubstituted C₅-C₂₀-aryl.

The substituents of the oxazolidine derivative (II) are especially preferably as follows:
R⁸ and R^{8′} are each independently selected from the group consisting of unsubstituted C₁-C₅-alkanediyl,
R⁹, R^{9′}, R¹⁰ and R^{10′} are each independently selected from the group consisting of hydrogen, unsubstituted or at least monosubstituted C₁-C₅-alkyl,
   wherein
   the substituents are selected from the group consisting of C₁-C₅-alkyl;
R¹¹, R^{11′}, R¹², R^{12′}, R¹³, R^{13′}, R¹⁴ and R^{14′} are hydrogen.

The substituents of the oxazolidine derivative (II) are most preferably as follows:
R⁸ and R^{8′} are identical and selected from the group consisting of unsubstituted C₁-C₅-alkanediyl,
R⁹ and R^{9′} are identical and selected from the group consisting of hydrogen, unsubstituted or at least monosubstituted C₁-C₅-alkyl,
   wherein
   the substituents are selected from the group consisting of C₁-C₅-alkyl;
R¹⁰, R^{10′}, R¹¹, R^{11′}, R¹², R^{12′}, R¹³, R^{13′}, R¹⁴ and R^{14′} are hydrogen.

The at least one oxazolidine derivative (component D)) is particularly preferably an oxazolidine derivative (I), the remarks and preferences described above applying for the oxazolidine derivative (I).

The at least one oxazolidine derivative (component (D)) is particularly preferably selected from the group consisting of 3-(1,3-oxazolidine)ethanol-2-(1-methylethyl)-3,3′-carbonate and 3-butyl-2-(1-ethylpentyl)-1,3-oxazolidine and the at least one oxazolidine derivative (component (D)) is most preferably 3-butyl-2-(1-ethylpentyl)-1,3-oxazolidine.

The present invention therefore also provides a process where the at least one oxazolidine derivative (component (D)) is selected from the group consisting of 3-(1,3-oxazolidine)ethanol-2-(1-methylethyl)-3,3′-carbonate and 3-butyl-2-(1-ethylpentyl)-1,3-oxazolidine.

3-butyl-2-(1-ethylpentyl)-1,3-oxazolidine has the CAS no. 165101-57-5 and is also known under the trade name Incozol 2.

3-(1,3-oxazolidine)ethanol-2-(1-methylethyl)-3,3′-carbonate has the CAS no. 145899-78-1 and is also known under the name carbonato bis(-N-ethyl,2-isopropyl-1,3-oxazolane) and the trade name Incozol LV.

C₁-C₃₀ alkyl is to be understood as meaning saturated and unsaturated, preferably saturated, hydrocarbons having a free valence (free radical) and from 1 to 30 carbon atoms. The hydrocarbons may be linear or cyclic. They may likewise comprise a cyclic component and a linear component. Example of such alkyl groups are methyl, ethyl, n-propyl, n-butyl, hexyl and cyclohexyl. Corresponding remarks also apply for C₁-C₂₀-alkyl and for C₁-C₁₀-alkyl, C₁-C₅-alkyl, C₁-C₄-alkyl and C₁-C₆-alkyl.

“C₅-C₃₀-Aryl” is to be understood as meaning the radical of an aromatic hydrocarbon having 5 to 30 carbon atoms. An aryl thus comprises an aromatic ring system. This ring system may be monocyclic, bicyclic or polycyclic. Examples of aryl groups are phenyl and naphthyl, for example 1-naphthyl and 2-naphthyl. Corresponding remarks also apply for C₅-C₂₀-aryl.

In the context of the present invention “C₁-C₁₀-alkanediyl” is to be understood as meaning a hydrocarbon having 1 to 10 carbon atoms and two free valences. A diradical having 1 to 10 carbon atoms is therefore concerned. “C₁-C₁₀-alkanediyl” comprehends both linear and cyclic and also saturated and unsaturated hydrocarbons having 1 to 10 carbon atoms and two free valences. Hydrocarbons having a linear proportion and a cyclic proportion are likewise encompassed by the term “C₁-C₁₀-alkanediyl”. Examples of C₁-C₁₀-alkanediyl are methylene, ethylene (ethane-1,2-diyl, dimethylene), propane-1,3-diyl (trimethylene), propylene (propane-1,2-diyl) and butane-1,4-diyl (tetramethylene). Corresponding remarks apply for “C₁-C₅-Alkandiyl”.

Production of the Polyamide (P)

To produce the polyamide (P) the mixture (M) is reacted. The mixture (M) may be reacted by any method known to one skilled in the art.

The reaction of the mixture (M) may be performed in any reactors known to one skilled in the art which are suitable for use at the temperatures at which the mixture (M) is reacted. The mixture (M) is preferably reacted in a mold.

The mixture (M) may be introduced into this mold by injection or pouring for example. Suitable methods of injection include all methods known to one skilled in the art. When the mixture is for example introduced into the mold by injection or pouring it is typically introduced into the mold in the liquid state. It is further possible to introduce the mixture (M) into the mold as a solid, for example as a powder. Processes therefor are known to one skilled in the art.

The components (A) to (D) and optionally the at least one filler and additives may be introduced into the reactor, preferably into the mold, together. It is likewise possible to introduce them into the reactor, preferably into the mold, separately.

In a preferred embodiment of the present invention the components (A) to (D) are introduced into the mold separately. The introducing of the components (A) to (D) into the reactor then comprises the following steps for example:
a) provision of a first mixture (M1) comprising the components
   (A) at least one lactam,
   (B) at least one catalyst,
   (D) at least one oxazolidine derivative,
b) provision of a second mixture (M2) comprising the components
   (A) at least one lactam,
   (C) at least one activator,
c) mixing of the first mixture (M1) with the second mixture (M2) to obtain the mixture (M).

It is also possible for the introducing of the components (A) to (D) into the reactor to comprise the following steps for example:
a) provision of a first mixture (M1) comprising the components
   (A) at least one lactam,
   (B) at least one catalyst,
b) provision of a second mixture (M2) comprising the components
   (A) at least one lactam,
   (C) at least one activator,
   (D) at least one oxazolidine derivative,
c) mixing of the first mixture (M1) with the second mixture (M2) to obtain the mixture (M).

The first mixture (M1) and the second mixture (M2) may each be provided by any method known to one skilled in the art.

The mixing of the first mixture (M1) with the second mixture (M2) may be effected by any method known to one skilled in the art. For example the first mixture (M1) and the second mixture (M2) may be mixed directly in the mold to obtain the mixture (M). It is likewise possible and preferable in accordance with the invention when the first mixture (M1) and the second mixture (M2) are mixed in a suitable mixing apparatus to obtain the mixture (M) which is then introduced into the mold subsequently. It is preferable when the mixture (M) is produced and subsequently introduced into the mold. Suitable mixing apparatuses are known to one skilled in the art, for example static and/or dynamic mixers.

The reaction of the mixture (M) may be effected at any desired temperature T. Said reaction is preferably effected at a temperature above the melting point T_{M(A)} of the component (A) present in the mixture (M). When two or more lactams are employed as component (A) then the reaction of the mixture (M) is preferably effected at a temperature T above the melting point T_{M(A)} of the lactam having the highest melting point T_{M(A)}.

The reaction of the mixture (M) is thus preferably effected at a temperature T greater than the melting point T_{M(A)} of the component (A).

The present invention accordingly also provides a process where the component (A) present in the mixture (M) has a melting point T_{M(A)} and the reaction of the mixture (M) takes place at a temperature T greater than the melting point T_{M(A)} of the component (A).

It is thus preferable for the component (A) to be present in a molten and therefore liquid state during the reaction of the mixture (M). The other components (B), (C) and (D) present in the mixture and optionally the additives may then likewise be present in a molten and therefore liquid state while they may equally be present dissolved in component (A). The at least one filler optionally present in the mixture (M) typically does not dissolve in the mixture (M) and typically is not present in a molten state either. When the mixture (M) comprises the at least one filler then said filler is typically present dispersed in the preferably molten component (A) during the reaction of the mixture (M). The at least one filler then forms the disperse phase while the components (A) and optionally the components (B), (C), (D) and the additives form the dispersion medium (the continuous phase).

It is additionally preferable when the polyamide (P) produced with the process according to the invention has a melting point T_{M(P)} and the reaction of the mixture (M) takes place at a temperature T smaller than the melting point T_{M(P)} of the polyamide (P).

The present invention accordingly also provides a process where the polyamide (P) has a melting point T_{M(P)} and the reaction of the mixture (M) takes place at a temperature T smaller than the melting point T_{M(P)} of the polyamide (P).

The “melting point T_{M(P)} of the polyamide (P)” is to be understood as meaning the melting point of the polyamide (P) produced with the process according to the invention.

The temperature T during the reaction of the mixture (M) is for example in the range from 50° C. to 250° C., preferably in the range from 80° C. to 200° C. and especially preferably in the range from 100° C. to 180° C. It is particularly preferable when the temperature T during the reaction of the mixture (M) is below the melting point T_{M(P)} of the polyamide (P). The temperature T during the reaction of the mixture (M) is thus preferably smaller than the melting point T_{M(P)} of the polyamide (P).

The reaction of the mixture (M) may be performed at any desired pressure.

Polyamide (P)

According to the invention the reaction of the mixture (M) affords the polyamide (P).

The crystallinity of the polyamide (P) is typically in the range from 10% to 70%, preferably in the range from 20% to 60% and especially preferably in the range from 25% to 45% determined by differential scanning calorimetry; DSC. Processes for determining the crystallinity of the polyamide (P) by DSC are known to one skilled in the art.

The melting point T_{M(P)} of the obtained polyamide (P) is for example in the range of >160° C. to 280° C., preferably in the range of 180° C. to 250° C. and especially preferably in the range of 200° C. to 230° C.

The glass transition temperature of the obtained polyamide (P) is for example in the range of 20° C. to 150° C., preferably in the range of 30° C. to 110° C. and especially preferably in the range of 40° C. to 80° C.

The melting point T_{M(P)} and the glass transition temperature of the obtained polyamide (P) are determined by differential scanning calorimetry; DSC. Processes therefor are known to one skilled in the art.

The proportion of unreacted component (A) in the obtained polyamide (P) is typically in the range of 0.01 to 6 wt %, preferably in the range of 0.1 to 3 wt % and especially preferably in the range of 1 to 2 wt % in each case based on the total weight of the obtained polyamide (P).

The viscosity number of the obtained polyamide (P) is typically in the range of 50 to 1000, preferably in the range of 200 to 800 and especially preferably in the range of 400 to 750 determined with 96% sulfuric acid as solvent at a temperature of 25° C. with a DIN Ubbelohde II capillary.

The present invention therefore further provides a polyamide (P) obtainable by the process according to the invention.

It was found that, surprisingly, the use of an oxazolidine derivative in a polyamide increases the crystallization rate of the polyamide (P).

The present invention accordingly also provides for the use of an oxazolidine derivative in a polyamide (P) for increasing the crystallization rate of the polyamide (P).

The above-described remarks and preferences for the at least one oxazolidine derivative (component (D)) present in the mixture (M) apply correspondingly for the oxazolidine derivative.

According to the invention the crystallization rate of the polyamide (P) is determined as follows: The point in time at which the mixture (M) is available and the temperature of the mixture (M) is at the temperature T at which the reaction of the mixture (M) takes place is referred to as the starting point t_{Start}. The starting point t_{Start} denotes the point in time from which the time to crystal formation is measured. The point in time of crystal formation is determined visually. The mixture (M) is reacted from the starting point t_{Start}. The reaction of the mixture (M) proceeds in exothermic fashion, i.e. energy is released during the reaction and the temperature T increases. The polyamide (P) is formed. The time is stopped as soon as soon as a clouding of the mixture (M) is perceptible. The time that elapses between the starting point t_{Start} and a clouding of the mixture (M) becoming perceptible is then the time to crystal formation of the polyamide (P). The crystallization rate may be ascertained therefrom. It is also possible upon commencement of clouding of the mixture (M) for formed polyamide and/or oligomers thereof to precipitate and contribute to the clouding of the mixture (M).

The mixture (M) according to the invention may be used to produce a molded article from the polyamide (P). Processes therefor are known to one skilled in the art. The mixture (M) according to the invention reduces the demolding time of the molded article.

The present invention therefore also provides for the use of an oxazolidine derivative in a polyamide (P) for producing a molded article from the polyamide (P) for reducing the demolding time of the molded article.

The above-described remarks and preferences for the at least one oxazolidine derivative (component (D)) present in the mixture (M) apply correspondingly for the oxazolidine derivative.

The demolding time of the molded article is determined as follows: The mixture (M) is reacted at a temperature T. At a point in time t_{demstart} the polyamide (P) produced during the reaction of the mixture (M) begins to detach from the wall of the reactor and shrinks. This point in time t_{demstart} is the commencement of the measurement. As soon as the polyamide (P) produced during the reaction of the mixture (M) stops shrinking, the point in time t_{demend} is reached and the measurement is terminated. The demolding time is then the time that elapses between the point in time t_{demstart} and the point in time t_{demend}. The point in time t_{demend} is also referred to as the demolding point. The demolding time is also referred to as the shrinking time.

The oxazolidine derivative may further be used in a reaction mixture (RM) comprising the components

(A) at least one lactam,

(B) at least one catalyst,

(C) at least one activator,

(D) at least one oxazolidine derivative,

(E) water

for removing water (component (E)) from the reaction mixture (RM).

The present invention therefore also provides for the use of an oxazolidine derivative in a reaction mixture (RM) comprising the components

(A) at least one lactam,

(B) at least one catalyst,

(C) at least one activator,

(D) at least one oxazolidine derivative,

(E) water

for removing the water from the reaction mixture (RM).

The same remarks and preferences as described hereinabove for the components (A) to (D) present in the mixture (M) apply correspondingly for the components (A) to (D) present in the reaction mixture (RM) and to the weight fraction thereof in the reaction mixture (RM).

The reaction mixture (RM) comprises for example in the range from 0.01 to 5000 ppm of the component (E), preferably in the range from 0.1 to 1000 ppm of the component (E) and especially preferably in the range from 1 to 700 ppm of the component (E) in each case based on the total weight of the reaction mixture (RM).

The sum of the weight percentages of the components (A) to (E) present in the reaction mixture (RM) typically adds up to 100%.

The above-described remarks and preferences for the at least one oxazolidine derivative (component (D)) present in the mixture (M) apply correspondingly for the oxazolidine derivative.

Also provided for is the use according to the invention wherein the at least one oxazolidine derivative is selected from the group consisting of an oxazolidine derivative of general formula (I)

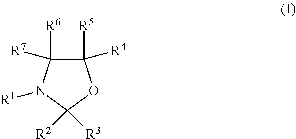

where
R¹, R², R³, R⁴, R⁵, R⁶ and R⁷ are each independently selected from the group consisting of hydrogen, unsubstituted or at least monosubstituted C₁-C₃₀-alkyl and unsubstituted or at least monosubstituted C₅-C₃₀-aryl,
   wherein
   the substituents are selected from the group consisting of NR^{a}R^{b}, OR^{c}, C₁-C₁₀-alkyl, C₅-C₁₀-aryl, F, Cl and Br,
   wherein
   R^{a}, R^{b} and R^{c} are each independently selected from the group consisting of hydrogen and unsubstituted C₁-C₁₀-alkyl,
      and an oxazolidine derivative of general formula (II)

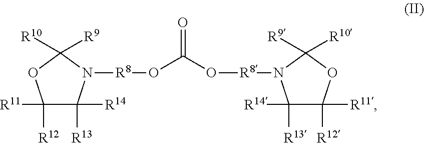

in which
R⁸ and R^{8′} are each independently selected from the group consisting of unsubstituted or at least monosubstituted C₁-C₁₀-alkanediyl,
   wherein
   the substituents are selected from the group consisting of C₁-C₁₀-alkyl;
R⁹, R^{9′}, R¹⁰, R^{10′}, R¹¹, R^{11′}, R¹², R^{12′}, R¹³, R^{13′}, R¹⁴ and R^{14′} are each independently selected from the group consisting of hydrogen, unsubstituted or at least monosubstituted C₁-C₃₀-alkyl and unsubstituted or at least monosubstituted C₅-C₃₀-aryl,
   wherein
   the substituents are selected from the group consisting of NR^{d}R^{e}, OR^{f}, C₁-C₁₀-alkyl, C₅-C₁₀-aryl, F, Cl and Br,
   wherein
   R^{d}, R^{e} and R^{f} are each independently selected from the group consisting of hydrogen and unsubstituted C₁-C₁₀-alkyl.

The invention is hereinbelow more particularly elucidated by examples without being limited thereto.

### EXAMPLES

The following components were employed:

(A) Lactam
Caprolactam (BASF SE, Ludwigshafen)

(B) Catalyst
Brüggolen C10 (17-19 wt % sodium caprolactamate in caprolactam) (Bruggemann KG, Heilbronn)

(C) Activator
Brüggolen C20 (80 wt % hexamethylene-1,6-dicarbamoylcaprolactam in caprolactam) (Bruggemann KG, Heilbronn)

(D1) Oxazolidine derivative
Incozol 2 (3-butyl-2-(1-ethylpentyl)-1,3-oxazolidine) (Incorez Ltd, Miller Street, Preston, Lancashire, PR1 1EA, England)

(D2) Oxazolidin derivative
Incozol LV (3-(1,3-oxazolidine)ethanol-2-(1-methylethyl)-3,3′-carbonate) (Incorez Ltd, Miller Street, Preston, Lancashire, PR1 1EA, England)

### Comparative Example V1

9.4 g (94 wt %) of dry caprolactam having a water content of 30 ppm were heated to 140° C. After addition of 0.4 g (4 wt %, 0.6 mol %) of catalyst (Brüggolen C10) and renewed attainment of the reaction temperature the polymerization was initiated by addition of 0.2 g (2 wt %, 0.5 mol %) of activator (Brüggolen C20). After 15 min the polymerization was quenched by cooling of the reaction vessel in ice-water (0° C.).

### Examples B2 to B7

Dry caprolactam having a water content of 30 ppm and Incozol 2 were heated to 140° C. in the amounts reported in table 1. After addition of the catalyst in the amounts reported in table 1 and renewed attainment of the reaction temperature the polymerization was initiated by addition of the activator (Brüggolen C20) in the amounts reported in table 1. After 15 min the polymerization was quenched by cooling of the reaction vessel in ice-water (0° C.).

TABLE 1

| | Caprolactam | | Catalyst | | Activator | | Incozol 2 | | |
|---|---|---|---|---|---|---|---|---|---|
| Example | [g] | [wt %] | [g] | [wt %] | [g] | [wt %] | [g] | [wt %] | [mol %] |
| B2 | 9.35 | 93.5 | 0.4 | 4 | 0.2 | 2 | 0.05 | 0.5 | 0.25 |
| B3 | 9.3 | 93 | 0.4 | 4 | 0.2 | 2 | 0.1 | 1 | 0.5 |
| B4 | 9.2 | 92 | 0.4 | 4 | 0.2 | 2 | 0.2 | 2 | 1.0 |
| B5 | 9.01 | 90.1 | 0.4 | 4 | 0.2 | 2 | 0.39 | 3.9 | 2.0 |
| B6 | 8.64 | 86.4 | 0.4 | 4 | 0.2 | 2 | 0.76 | 7.6 | 4.0 |
| B7 | 8.28 | 82.8 | 0.4 | 4 | 0.2 | 2 | 1.12 | 11.2 | 6.0 |

### Examples B8 to B12

Dry caprolactam having a water content of 30 ppm and Incozol LV were heated to 140° C. in the amounts reported in table 2. After addition of the catalyst (Brüggolen C10) in the amounts reported in table 2 and renewed attainment of the reaction temperature the polymerization was initiated by addition of the activator (Brüggolen C20) in the amounts reported in table 2. After 15 min the polymerization was quenched by cooling of the reaction vessel in ice-water (0° C.).

TABLE 2

| | Caprolactam | | Catalyst | | Activator | | Incozol LV | | |
|---|---|---|---|---|---|---|---|---|---|
| Example | [g] | [wt %] | [g] | [wt %] | [g] | [wt %] | [g] | [wt %] | [mol %] |
| B8 | 9.35 | 93.5 | 0.4 | 4 | 0.2 | 2 | 0.05 | 0.5 | 0.3 |
| B9 | 9.3 | 93 | 0.4 | 4 | 0.2 | 2 | 0.1 | 1 | 0.7 |
| B10 | 9.2 | 92 | 0.4 | 4 | 0.2 | 2 | 0.2 | 2 | 1.3 |
| B11 | 9.0 | 90 | 0.4 | 4 | 0.2 | 2 | 0.4 | 4 | 2.7 |
| B12 | 8.8 | 88 | 0.4 | 4 | 0.2 | 2 | 0.6 | 6 | 4.2 |

The mol % values for Incozol LV reported in table 2 relate to moles of oxazolidine units.

### Comparative Example V13

9.4 g (94 wt %) of caprolactam having a water content of 350 ppm were heated to 140° C. After addition of 0.4 g (4 wt %, 0.6 mol %) of catalyst (Brüggolen C10) and renewed attainment of the reaction temperature the polymerization was initiated by addition of 0.2 g (2 wt %, 0.5 mol %) of activator (Brüggolen C20). After 15 min the polymerization was quenched by cooling of the reaction vessel in ice-water (0° C.).

### Examples B14 to B19

Caprolactam having a water content of 350 ppm and Incozol 2 were heated to 140° C. in the amounts reported in table 3. After addition of the catalyst (Brüggolen C10) in the amounts reported in table 3 and renewed attainment of the reaction temperature the polymerization was initiated by addition of the activator (Brüggolen C20) in the amounts reported in table 3. After 15 min the polymerization was quenched by cooling of the reaction vessel in ice-water (0° C.).

TABLE 3

| | Caprolactam | | Catalyst | | Activator | | Incozol 2 | | |
|---|---|---|---|---|---|---|---|---|---|
| Example | [g] | [wt %] | [g] | [wt %] | [g] | [wt %] | [g] | [wt %] | [mol %] |
| B14 | 9.35 | 93.5 | 0.4 | 4 | 0.2 | 2 | 0.05 | 0.5 | 0.25 |
| B15 | 9.3 | 93 | 0.4 | 4 | 0.2 | 2 | 0.1 | 1 | 0.5 |
| B16 | 9.2 | 92 | 0.4 | 4 | 0.2 | 2 | 0.2 | 2 | 1.0 |
| B17 | 9.01 | 90.1 | 0.4 | 4 | 0.2 | 2 | 0.39 | 3.9 | 2.0 |
| B18 | 8.64 | 86.4 | 0.4 | 4 | 0.2 | 2 | 0.76 | 7.6 | 4.0 |
| B19 | 8.28 | 82.8 | 0.4 | 4 | 0.2 | 2 | 1.12 | 11.2 | 6.0 |

### Comparative Example V20

9.4 g (94 wt %) of caprolactam having a water content of 700 ppm were heated to 140° C. After addition of 0.4 g (4 wt %, 0.6 mol %) of catalyst (Brüggolen C10) and renewed attainment of the reaction temperature the polymerization was initiated by addition of 0.2 g (2 wt %, 0.5 mol %) of activator (Brüggolen C20). After 15 min the polymerization was quenched by cooling of the reaction vessel in ice-water (0° C.).

### Examples B21 to B26

Caprolactam having a water content of 700 ppm and Incozol 2 were heated to 140° C. in the amounts reported in table 4. After addition of the catalyst in the amounts reported in table 4 and renewed attainment of the reaction temperature the polymerization was initiated by addition of the activator (Brüggolen C20) in the amounts reported in table 4. After 15 min the polymerization was quenched by cooling of the reaction vessel in ice-water (0° C.).

TABLE 4

| | Caprolactam | | Catalyst | | Activator | | Incozol 2 | | |
|---|---|---|---|---|---|---|---|---|---|
| Example | [g] | [wt %] | [g] | [wt %] | [g] | [wt %] | [g] | [wt %] | [mol %] |
| B21 | 9.35 | 93.5 | 0.4 | 4 | 0.2 | 2 | 0.05 | 0.5 | 0.25 |
| B22 | 9.3 | 93 | 0.4 | 4 | 0.2 | 2 | 0.1 | 1 | 0.5 |
| B23 | 9.2 | 92 | 0.4 | 4 | 0.2 | 2 | 0.2 | 2 | 1.0 |
| B24 | 9.01 | 90.1 | 0.4 | 4 | 0.2 | 2 | 0.39 | 3.9 | 2.0 |
| B25 | 8.64 | 86.4 | 0.4 | 4 | 0.2 | 2 | 0.76 | 7.6 | 4.0 |
| B26 | 8.28 | 82.8 | 0.4 | 4 | 0.2 | 2 | 1.12 | 11.2 | 6.0 |

### Comparative Example V27

9.4 g (94 wt %) of caprolactam having a water content of 530 ppm were heated to 140° C. After addition of 0.4 g (4 wt %, 0.6 mol %) of catalyst (Brüggolen C10) and renewed attainment of the reaction temperature the polymerization was initiated by addition of 0.2 g (2 wt %, 0.5 mol %) of activator (Brüggolen C20). After 15 min the polymerization was quenched by cooling of the reaction vessel in ice-water (0° C.).

### Examples B28 to B29

Caprolactam having a water content of 530 ppm and Incozol LV were heated to 140° C. in the amounts reported in table 5. After addition of the catalyst in the amounts reported in table 5 and renewed attainment of the reaction temperature the polymerization was initiated by addition of the activator (Brüggolen C20) in the amounts reported in table 5. After 15 min the polymerization was quenched by cooling of the reaction vessel in ice-water (0° C.).

TABLE 5

| | Caprolactam | | Catalyst | | Activator | | Incozol LV | | |
|---|---|---|---|---|---|---|---|---|---|
| Example | [g] | [wt %] | [g] | [wt %] | [g] | [wt %] | [g] | [wt %] | [mol %] |
| B28 | 9.3 | 93 | 0.4 | 4 | 0.2 | 2 | 0.1 | 1 | 0.7 |
| B29 | 9.2 | 92 | 0.4 | 4 | 0.2 | 2 | 0.2 | 2 | 1.3 |

Residual Monomer Content

Analogously to the comparative example V1 and the examples B2 to B7 caprolactam was reacted in the presence of the catalyst, the activator and Incozol 2. Caprolactam having three different water contents was employed (40 ppm, 130 ppm, 350 ppm). The residual monomer content in the obtained polyamide (P) was determined as a function of the amount of the employed Incozol 2. The results are shown in FIG. 7.

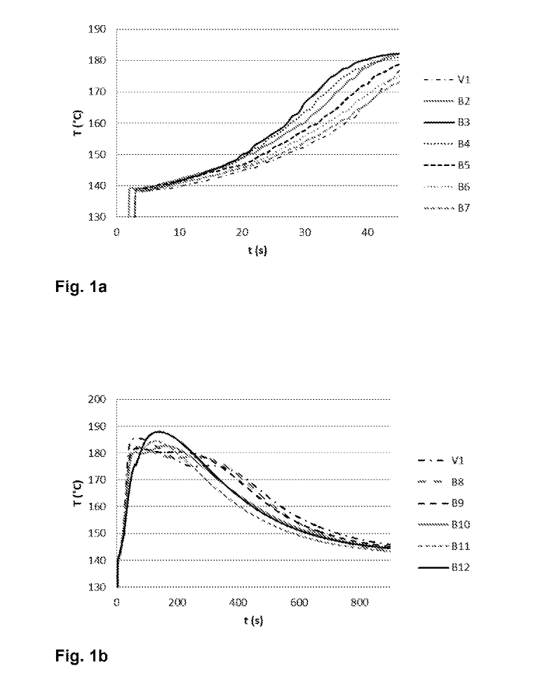

FIGS. 1 to 6 show the results for the various examples.

FIG. 1a shows the effect of Incozol 2 as the oxazolidine derivative on the reactivity of the mixture (M). FIG. 1b shows the effect of Incozol LV as the oxazolidine derivative on the reactivity of the mixture (M). The X-axes denote time t in seconds (s) and the Y axes denote temperature T in ° C. The reaction of the mixture (M) is exothermic. Thus energy is released during the reaction of the mixture (M) and the mixture (M) heats up during the reaction. To determine the reactivity the temperature T of the mixture (M) was measured as a function of time t. The starting point t_{Start} (0 s) was the point in time at which the mixture (M) was available and had a temperature T of 140° C. The more rapid the change in the temperature T of the mixture (M), the more rapid the reaction of the mixture (M) and the higher the reactivity of the mixture (M).

It is apparent from figure la that the addition of Incozol 2 as the oxazolidine derivative increases the reactivity of the mixture (M), i.e. that the temperature T of the mixture (M) changes more rapidly than without the addition of Incozol 2 as the oxazolidine derivative (comparative example V1).

It is apparent from FIG. 1b that as a result of the addition of Incozol LV as the oxazolidine derivative the reactivity of the mixture (M) is similar to the reactivity of the mixture without addition of Incozol LV as the oxazolidine derivative (comparative example V1). In addition, the reaction proceeds in a similarly exothermic fashion as the reaction of the mixture without Incozol LV as the oxazolidine derivative.

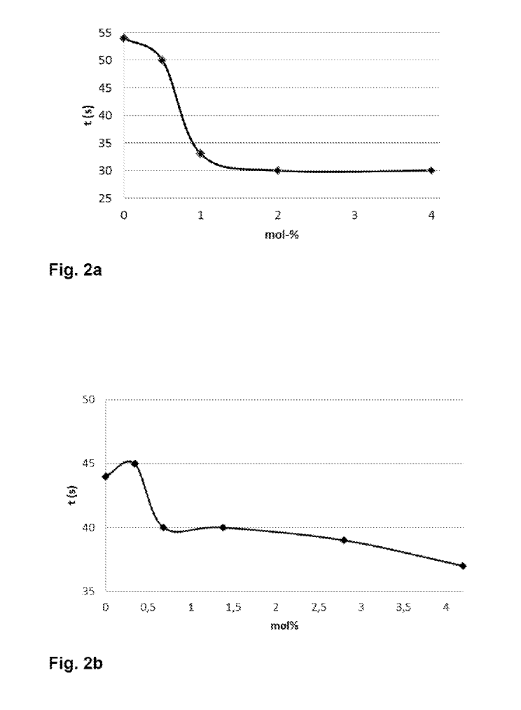

FIG. 2a shows the time to crystal formation as a function of the amount of Incozol 2 as the oxazolidine derivative present in the mixture (M). The X-axis represents the amount of Incozol 2 present in the mixture (M) in mol % and the Y-axis shows the time t in seconds (s) between the provision of the mixture (M) at 140° C. and the becoming apparent of a clouding of the mixture (M). It is apparent from FIG. 2a that with increasing proportion of Incozol 2 as the oxazolidine derivative the time until onset of clouding and thus until commencement of crystal formation is markedly reduced.

FIG. 2b shows the time to crystal formation as a function of the amount of Incozol LV as the oxazolidine derivative present in the mixture (M). The X-axis represents the amount of Incozol LV present in the mixture (M) in mol % and the Y-axis shows the time t in seconds (s) between the provision of the mixture (M) at 140° C. and the becoming apparent of a clouding of the mixture (M). It is apparent from FIG. 2b that with increasing proportion of Incozol LV as the oxazolidine derivative the time until onset of clouding and thus until commencement of crystal formation is likewise markedly reduced.

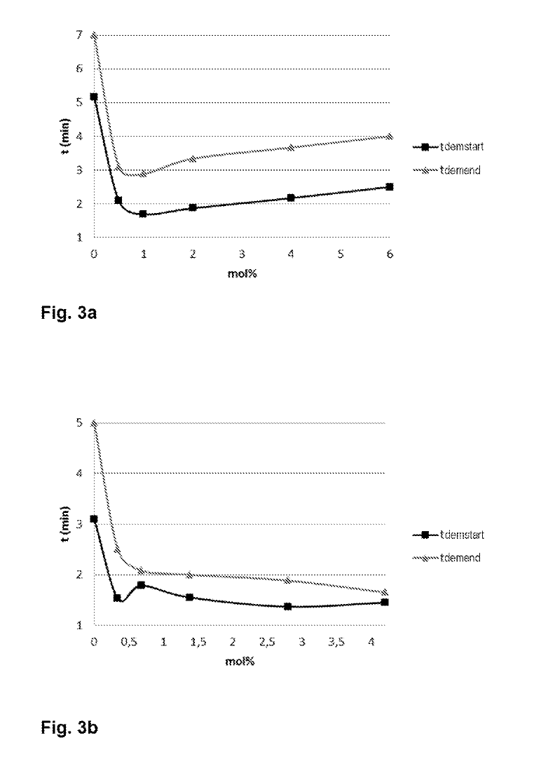

FIG. 3a shows the demolding time for different contents of Incozol 2 as the oxazolidine derivative in the mixture (M). The X-axis represents the proportion of oxazolidine derivative in the mixture (M) in mol % and the Y-axis represents the time tin minutes (min). To determine the demolding time the point in time t_{demstart} at which the polyamide (P) produced during the reaction of the mixture (M) begins to detach from the wall of the reactor was determined. As soon as the polyamide (P) produced during the reaction of the mixture (M) stops shrinking, the point in time t_{demend} is reached. The points in time t_{demstart} and t_{demend} are shown in FIG. 3a as a function of the Incozol 2 proportion. The difference between the two points in time is the demolding time. It is apparent that the demolding time is reduced by the oxazolidone derivative.

FIG. 3b shows the demolding time for different contents of Incozol LV as the oxazolidine derivative in the mixture (M). The X-axis represents the proportion of oxazolidine derivative in the mixture (M) in mol % and the Y-axis represents the time tin minutes (min). To determine the demolding time the point in time t_{demstart} at which the polyamide (P) produced in the reaction of the mixture (M) begins to detach from the wall of the reactor was determined. As soon as the polyamide (P) produced during the reaction of the mixture (M) stops shrinking, the point in time t_{demend} is reached. The points in time t_{demstart} and t_{demend} are shown in FIG. 3b as a function of the Incozol LV proportion. The difference between the two points in time is the demolding time. It is apparent that the demolding time is reduced by the oxazolidine derivative.

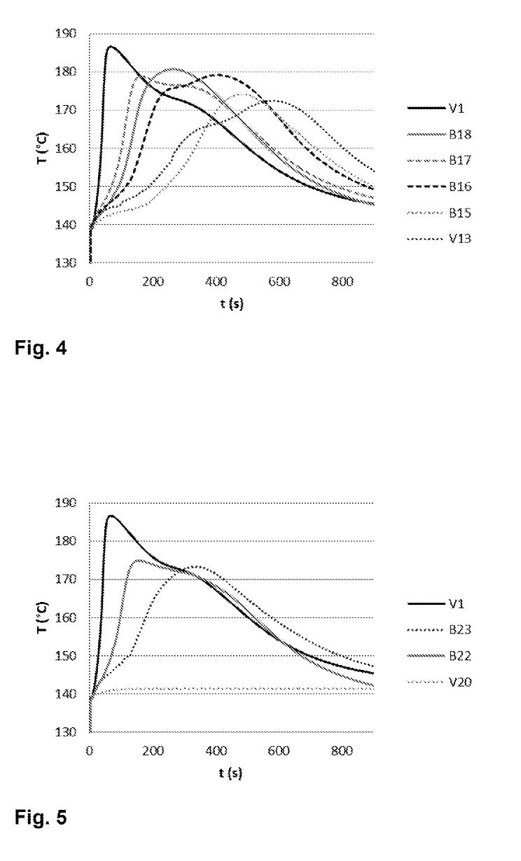

FIGS. 4 and 5 show how the reactivity of a reaction mixture (RM) comprising 350 ppm (FIG. 4) and 700 ppm (FIG. 5) of water is changed by the presence of Incozol 2 as the oxazolidinone derivative. The X-axes in each case show the time t in seconds (s) and the Y-axes show the temperature T of the reaction mixture (RM). It is apparent from the gradient of the curve that the reactivity is highest when dry caprolactam is used (comparative example V1) and lowest when caprolactam having a water content of 350 ppm (comparative example V13) and of 700 ppm (comparative example V20) is used. The use of Incozol 2 as the oxazolidinone derivative increases the reactivity compared to the use of caprolactam having a water content of 350 ppm (comparative example V13) and of 700 ppm (comparative example V20) without oxazolidine derivative.

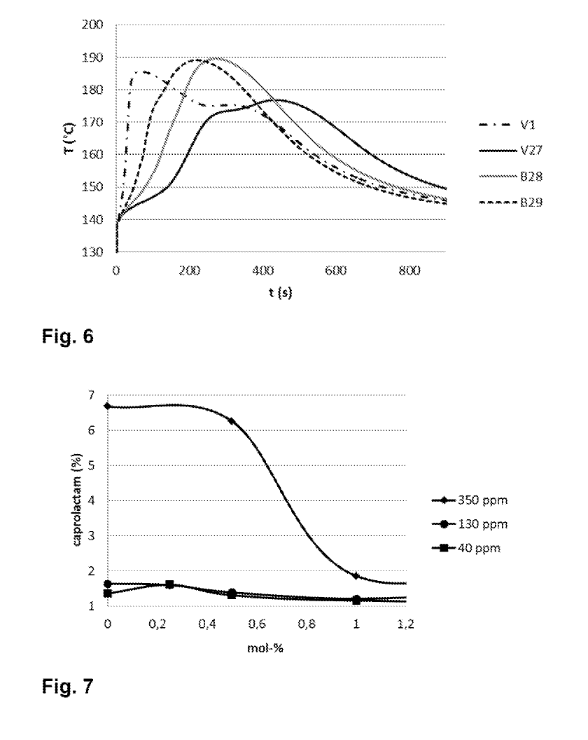

FIG. 6 shows how the reactivity of the reaction mixture (RM) comprising 530 ppm of water is changed by the presence of Incozol LV as the oxazolidine derivative. The X-axis shows the time t in seconds (s) and the Y-axis shows the temperature T of the reaction mixture (RM). It is apparent from the gradient of the curves that the reactivity is highest when dry caprolactam is used (comparative example V1) and lowest when caprolactam having a water content of 530 ppm (comparative example V27) is used. The use of Incozol LV as the oxazolidinone derivative increases the reactivity compared to the use of caprolactam having a water content of 530 ppm (comparative example V27) without oxazolidine derivative.

FIG. 7 shows the residual content of caprolactam (proportion of unreacted component (A)) in the produced polyamide (P) as a function of the employed amount of Incozol 2 as the oxazolidine derivative for different proportions of water in the employed caprolactam (component (A)). The X-axis represents the employed amount of oxazolidine derivative in mol % and the Y-axis the residual content of caprolactam in wt % based on the total weight of the polyamide (P). It is apparent that the residual content of caprolactam can be reduced with increasing proportion of oxazolidine derivative.

1. A process for producing a polyamide (P) by reacting a mixture (M), the mixture (M) comprising the components:
(A) at least one lactam,
(B) at least one catalyst selected from the group consisting of alkali metal lactamates, alkaline earth metal lactamates, alkali metals, alkaline earth metals, alkali metal hydrides, alkaline earth metal hydrides, alkali metal hydroxides, alkaline earth metal hydroxides, alkali metal alkoxides, alkaline earth metal alkoxides, alkali metal amides, alkaline earth metal amides, alkali metal oxides, alkaline earth metal oxides, and organometallic compounds,
(C) at least one activator selected from the group consisting of carbodiimides, isocyanates, acid anhydrides, acid halides, and the reaction products thereof with the component (A),
(D) at least one oxazolidine derivative selected from the group consisting of 3-(1,3 -oxazolidine)ethanol-2-(1-methylethyl)-3,3′-carbonate and 3-butyl-2-(1-ethylpentyl)-1,3-oxazolidine.

2. The process according to claim 1, wherein the component (A) present in the mixture (M) has a melting point T_{M(A)} , and wherein the reaction of the mixture (M) takes place at a temperature T greater than the melting point T_{M(A)} of the component (A).

3. The process according to claim 1, wherein the polyamide (P) has a melting point T_{M(P)}, and wherein the reaction of the mixture (M) takes place at a temperature T less than the melting point T_{M(P)} of the polyamide (P).

4. The process according to claim 1, wherein the component (A) present in the mixture (M) is at least one lactam comprising 4 to 12 carbon atoms.

5. The process according to claim 1, wherein the component (A) present in the mixture (M) is selected from the group consisting of pyrrolidone, piperidone, ε-caprolactam, enantholactam, caprylolactam, capriclactam, and laurolactam.

6. The process according to claim 1, wherein the mixture (M) comprises from 75 to 99.7 wt % of the component (A), from 0.1 to 5 wt % of the component (B), from 0.1 to 10 wt % of the component (C) and from 0.1 to 10 wt % of the component (D) based on the total weight of the mixture (M).

7. A mixture (M) comprising the components:
(A) at least one lactam,
(B) at least one catalyst selected from the group consisting of alkali metal lactamates, alkaline earth metal lactamates, alkali metals, alkaline earth metals, alkali metal hydrides, alkaline earth metal hydrides, alkali metal hydroxides, alkaline earth metal hydroxides, alkali metal alkoxides, alkaline earth metal alkoxides, alkali metal amides, alkaline earth metal amides, alkali metal oxides, alkaline earth metal oxides, and organometallic compounds,
(C) at least one activator selected from the group consisting of carbodiimides, isocyanates, acid anhydrides, acid halides and the reaction products thereof with the component (A),
(D) at least one oxazolidine derivative selected from the group consisting of 3-(1,3-oxazolidine)ethanol-2-(1-methylethyl)-3,3′-carbonate and 3-butyl-2-(1-ethylpentyl)-1,3-oxazolidine.

8. A method for increasing the crystallization rate of a polyamide (P) using an oxazolidine derivative in the polyamide (P) wherein the oxazolidine derivative is selected from the group consisting of 3-(1,3-oxazolidine)ethanol-2-(1-methylethyl)-3,3′-carbonate and 3-butyl-2-(1-ethylpentyl)-1,3-oxazolidine.

9. A method for producing a molded article from a polyamide (P) for reducing a demolding time of the molded article, wherein at least one oxazolidine derivative in the polyimide (P) is selected from the group consisting of 3-(1,3-oxazolidine)ethanol-2-(1-methylethyl)-3,3′-carbonate and 3-butyl-2-(1-ethylpentyl)-1,3-oxazolidine.

10. A method for removing water from a reaction mixture (RM) using an oxazolidine derivative in the reaction mixture (RM), the reaction mixture (RM) comprising the components:
(A) at least one lactam,
(B) at least one catalyst selected from the group consisting of alkali metal lactamates, alkaline earth metal lactamates, alkali metals, alkaline earth metals, alkali metal hydrides, alkaline earth metal hydrides, alkali metal hydroxides, alkaline earth metal hydroxides, alkali metal alkoxides, alkaline earth metal alkoxides, alkali metal amides, alkaline earth metal amides, alkali metal oxides, alkaline earth metal oxides, and organometallic compounds,
(C) at least one activator selected from the group consisting of carbodiimides, isocyanates, acid anhydrides, acid halides, and the reaction products thereof with the component (A),
(D) at least one oxazolidine derivative selected from the group consisting of 3-(1,3-oxazolidine)ethanol-2-(1-methylethyl)-3,3′-carbonate and 3-butyl-2-(1-ethylpentyl)-1,3-oxazolidine, and
(E) water.

11.-15. (canceled)
